(19) United States
(12) Patent Application Publication
(10) Pub. No.: US 2017/0341797 A1
(43) Pub. Date: Nov. 30, 2017

(54) DRUG PACKAGING DEVICE

(71) Applicant: CRETEM CO., LTD., Anyang-si, Gyeonggi-do (KR)

(72) Inventor: Ho Yeon KIM, Anyang-si, Gyeonggi-do (KR)

(73) Assignee: CRETEM CO., LTD., Anyang-si, Gyeonggi-do (KR)

(21) Appl. No.: 15/535,590

(22) PCT Filed: Dec. 14, 2015
(86) PCT No.: PCT/KR2015/013647

§ 371 Date: Jun. 13, 2017

(30) Foreign Application Priority Data
Dec. 15, 2014 (KR) 10-2014-0180757

(51) Int. Cl. B65B 61/08; B65B 9/06; B65B 9/02; B26F 1/10; B26D 1/40; B65B 51/16; B26D 1/36

(52) U.S. Cl. CPC B65B 61/08; B65B 51/16; B65B 9/06; B26D 1/365; B26F 1/10; B26D 1/405; B65B 9/02

(57) ABSTRACT

Disclosed is a drug packaging device including a packaging unit and a cutting unit. The packaging unit includes a pair of packaging rollers that are pressed against each other with a drug packaging member disposed therebetween, thereby forming isolation regions in the drug packaging member at regular intervals so that at least one drug accommodation section can be formed between the isolation regions. The cutting unit forms a non-continuous zigzag cut line in which peak-shaped cuts and valley-shaped cuts are alternatively arranged and separated by a plurality of uncut portions. With this structure, it is possible to contribute to improvement in durability of a drug packaging member as well as in cuttability of the drug packaging member.

### TECHNICAL FIELD

The present invention relates to a drug packaging device and, more particularly, to a drug packaging device capable of easily cutting a drug packaging member.

### BACKGROUND ART

Generally, a drug packaging member is made from a transparent and easily-openable material so that drugs in a drug packaging member can be seen and can be easily accessible. Examples of such a material include parchment paper, cellophane, and Polyethylene terephthalate (PET). Cellophane has advantages of high transparency, high cuttability, and low price, but has a disadvantage of low packageability. For example, cellophane is susceptible to moisture and can be easily wrinkled. Meanwhile, on the contrary to cellophane, parchment paper has disadvantages of low transparency and high price.

Meanwhile, PET, i.e. polyester, has similar transparency to cellophane but is relatively cheaper than cellophane. Therefore, PET is widely used as a drug packaging material. However, PET has relatively low cuttability compared with cellophane and parchment paper. Therefore, PET drug packaging members are required to have cut lines to improve cuttability. The cut lines of PET drug packaging members are generally formed with a pair of rollers equipped with respective blades.

When the rollers are pressed against each other to form cut lines in PET drug packaging members, when the pressing force is excessively strong, PET drug packaging members are likely to be damaged. Furthermore, noise is likely to occur and durability of the blades is deteriorated because the blades collide with each other. Conversely, when the pressing force is weaker than required, it is difficult to form cut lines in PET drug packaging members. Therefore, research on production of a drug packaging member having the same advantages as a PET packaging member while having high cuttability has been required.

### DISCLOSURE

### Technical Problem

Accordingly, the present invention has been made in view of the problems occurring in the related art and an object of the present invention is to provide a drug packaging device capable of producing an inexpensive, highly-transparent, and easily-cuttable drug packaging member.

### Technical Solution

In order to accomplish the object of the present invention, according to one aspect, there is provided a drug packaging device including: a packaging unit including a pair of packaging rollers pressed against each other with a drug packaging member disposed therebetween, the packaging unit forming at least one drug accommodation section for accommodating a drug by forming isolation regions at regular intervals in the drug packaging member; and a cutting unit forming a non-continuous zigzag cut line where peak-shaped cuts and valley-shaped cuts alternately occur and are separated from each other by a plurality of uncut portions.

According to the aspect, the uncut portions may be formed at middle portions of linear lines connecting the peak-shaped cuts and the valley-shaped cuts.

According to the aspect, the cutting unit may include: a cutting protrusion provided to at least one packaging roller of the pair of packaging rollers and configured to form the non-continuous zigzag cut line; and a non-cutting recess formed in the cutting protrusion and configured to form the uncut portions included in the non-continuous zigzag cut line.

According to the aspect, the cutting protrusion may include a teeth-like blade having a zigzag pattern and the non-cutting recess may be provided at a middle portion of the teeth-like blade in a widthwise direction of the cutting protrusion.

According to the aspect, the drug packaging member may be provided such that one drug packaging sheet is folded to be partially overlapped or a plurality of drug packaging sheets is arranged to be layered. The pair of packaging rollers may be rotated and pressed against each other with the drug packaging member disposed therebetween, thereby forming the isolation region that is a thermally bonded region. The isolation region may include a first bonded region extending in a lengthwise direction of the drug packaging member and a second bonded region extending in a widthwise direction of the drug packaging member. The packaging rollers may include: respective first pressing portions being pressed against each other in a radial direction of the packaging rollers to form the first bonded region; respective second pressing portions extending in a lengthwise direction of the packaging rollers and being pressed against each other to form the second bonded region; and respective packaging portions spaced from each other to form the drug accommodation section therebetween.

According to the aspect, the cutting protrusion may be provided to at least one second pressing portion of the second pressing portions of the pair of packaging rollers, configured to extend in the lengthwise direction of the packaging roller, and provided with the teeth-like blade having a zigzag form; and the non-cutting recesses may be formed to be recessed in the cutting protrusion in a radial direction of the packaging roller and may be provided at a middle portion of the teeth-like blade in a widthwise direction of the pair of cutting protrusions.

According to the aspect, the drug packaging sheet may be made of polyester (PET).

### Advantageous Effects

The present invention having the structure described above has advantages described below. First, according to the present invention, it is possible to produce a drug packaging member having a non-continuous cut line in an isolation region that isolates adjacent drug accommodation sections from each other. Therefore, it is possible to prevent the drug packaging member from being accidently erroneously torn when a user opens the drug packaging member to use a dose of drug. Therefore, the present invention contributes to improvement in durability of a drug packaging member.

Second, since erroneous tearing of a drug packaging member is prevented, it is possible to prevent drugs from accidently escaping from the drug packaging member and from being exposed to air.

Third, by forming the non-continuous zigzag cut line in the drug packaging member made from polyester having relatively low cuttability, it is possible to provide an inexpensive drug packaging member that can be easily cut and is highly transparent.

### DESCRIPTION OF DRAWINGS

FIG. 1 is a perspective view schematically illustrating a drug packaging device according to one embodiment of the present invention;

FIG. 2 is a schematic diagram of the drug packaging device of FIG. 1;

FIG. 3 is a schematic diagram of the device from which a cutting unit shown in FIG. 1 is removed; and

FIG. 4 is a cross-sectional view schematically illustrating operation of the drug packaging device of FIG. 1.

### BEST MODE

### Mode for Invention

Hereinafter, preferred embodiments of the present invention will be described with reference to the accompanying drawings.

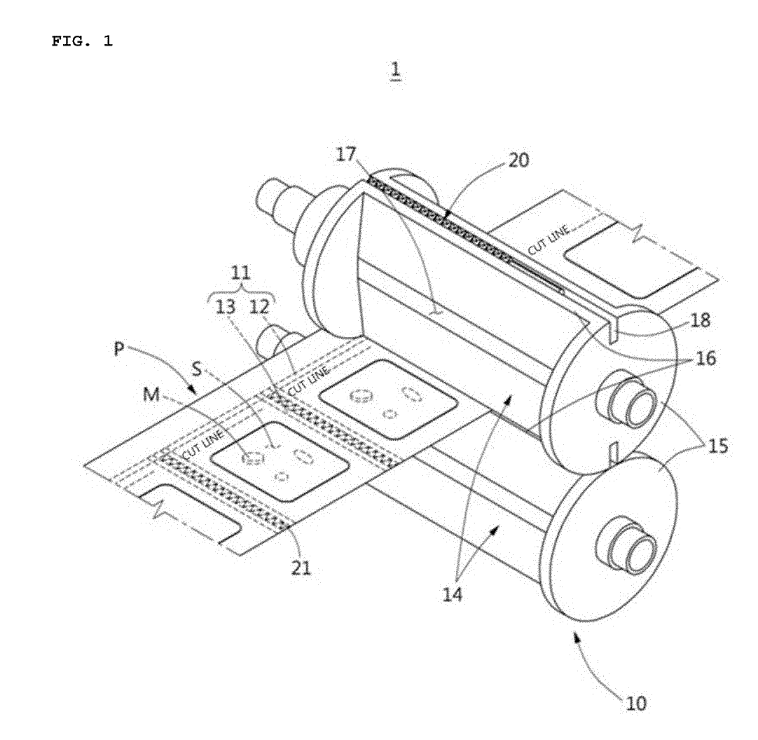

As illustrated in FIG. 1, according to one embodiment of the present invention, a drug packaging device 1 includes a packaging unit 10 and a cutting unit 20.

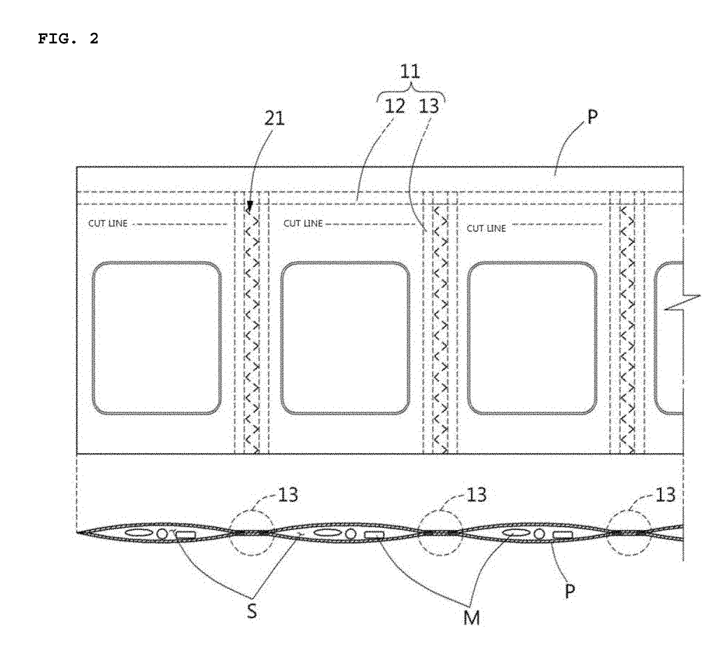

For reference, as illustrated in FIG. 2, the drug packaging unit 1 described in the present disclosure produces a drug packaging member P having at least one isolated drug accommodation section S in which a drug M can be accommodated. The drug packaging member P is formed with a drug packaging sheet that is folded to be at least partially overlapped or with a plurality of drug packaging sheets that are arranged to be layered. According to the preferred embodiment of the present invention, a plurality of drug accommodation sections S is arranged in the lengthwise direction of a strip of drug packaging member P. The drug packaging member P is preferably made from polyester, i.e. PET, which is transparent such that drugs M in a drug package can be seen and which is advantageous in terms of mass packaging due to low price.

The packaging unit 10 first forms isolation regions 11 at regular intervals in the drug packaging member P so that drug accommodation sections S to accommodate drugs M are formed between the isolation regions 11.

For reference, the isolation regions 11 in the drug packaging member P includes a first bonded region 12 extending in the lengthwise direction of the drug packaging member P and a second bonded region 13 extending in the widthwise direction of the drug packaging member P. Each drug accommodation section S having a square shape is defined by the first bonded region 12 and the second bonded region 13.

The packaging unit 10 includes a pair of packaging rollers 14 that are rotated with the drug packaging member P disposed therebetween. While being rotated, the packaging rollers press the drug packaging member P against the counterpart rollers, thereby forming the isolation regions 11 through thermal bonding. Each roller of the packaging rollers 14 includes first pressing portions 15, second pressing portions 16, and packaging portions 17. The packaging rollers 14 have the same construction as each other.

Specifically, opposite ends of each packaging roller 14 in a lengthwise direction of the packaging roller 14 are provided with the respective first pressing portions 15 that protrude in a radial direction of a roller shaft. The first pressing portions 15 of the two packaging rollers 14 are pressed against each other with the drug packaging member P disposed therebetween, thereby forming the first bonded region 12. In addition, each packaging roller of the pair of packaging rollers 14 is provided with the second pressing portions 16 extending in the lengthwise direction of the roller shaft. The second pressing portions 16 of the two packing rollers 14 extending in the lengthwise direction are pressed against each other with the drug packaging member P disposed therebetween, thereby forming the second bonded portion 13. In addition to the first pressing portions 15 and the second pressing portions 16, each of the packaging rollers 14 includes the packaging portions 17 to form the drug accommodation sections S in the drug packaging member P. The packaging portions of the two packaging rollers 14 are spaced from each other. Each of the packaging rollers 14 further includes a heating unit installed inside the packaging roller 14. Therefore, when the pair of the packaging rollers 14 are rotated, the first pressing portions 15 of the two packaging rollers 14 are pressed against each other with the drug packaging member P therebetween, thereby forming the first bonded region 12 is formed. Furthermore, when the pair of the packaging rollers 14 are rotated, the second pressing portions 16 of the two packaging rollers 14 are pressed against each other with the drug packaging member P therebetween, thereby forming the second bonded region.

The cutting unit 20 forms a non-continuous cut line 21 in the isolation regions 11. Specifically, the cutting unit 20 forms the non-continuous cut line 21 within the second bonded region 13 of the isolation region 11 of the drug packaging member P. The non-continuous cut line 21 has an overall zigzag pattern in which peak-shaped cuts and valley-shaped cuts are alternately arranged. The non-continuous cut line 21 further includes a plurality of uncut portions formed between the peak-shaped cuts and the valley-shaped cuts. Each uncut portion of the non-continuous cut line 21 is provided at a middle portion of a linear line connecting the peak-shaped cut and the valley-shaped cut.

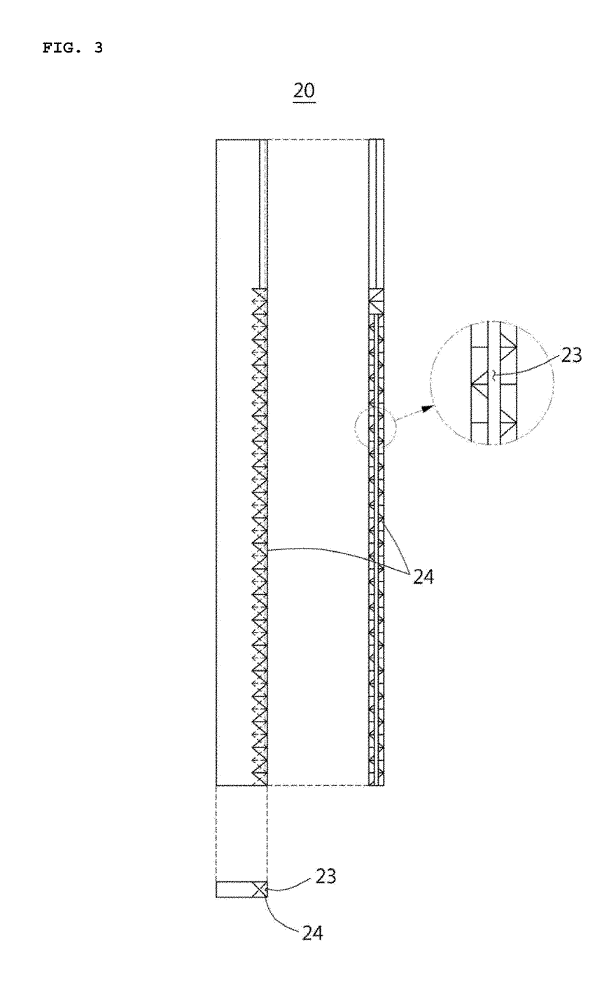

As illustrated in FIG. 3, the cutting unit 20 includes a cutting protrusion 22 and a non-cutting recess 23.

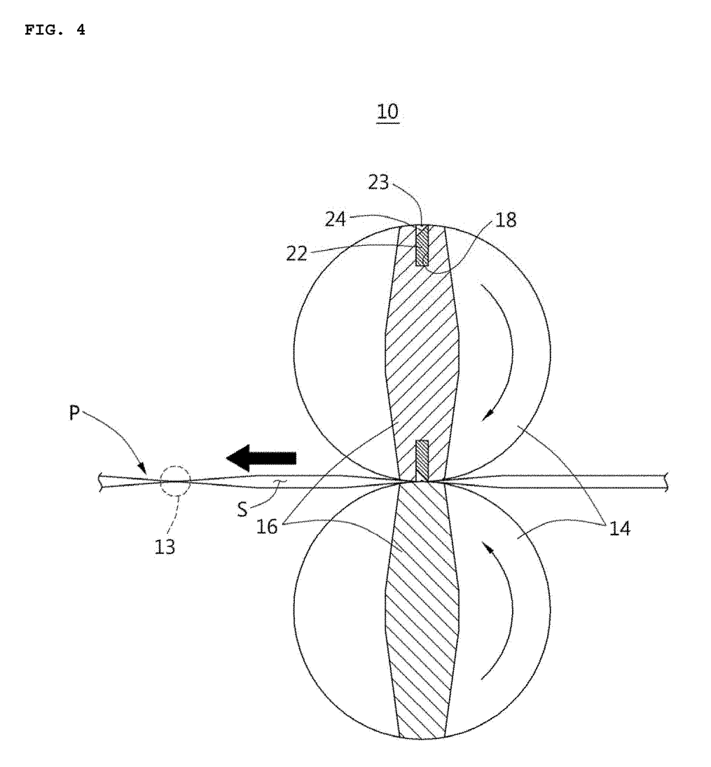

As illustrated in FIG. 4, the cutting protrusion 22 is provided to at least one roller of the pair of packaging rollers 14. In the present embodiment, there is a pair of cutting protrusions 22. The cutting protrusions 22 are installed in respective installation recesses 18 formed in the packaging rollers 14. Specifically, the cutting protrusions 22 are provided to the second pressing portions 16 of the packaging rollers 14 such that the cutting protrusions 22 of the packaging rollers 14 are engaged with each other along the lengthwise direction of the packaging rollers 14. As shown in FIG. 3, the cutting protrusion 22 has a teeth-like blade 24 having peak-shaped blade portions and valley-shaped blade portions arranged in a zigzag pattern, thereby forming the zigzag cut line 21 composed of peak-shaped cuts and valley-shaped cuts in the drug packaging member P.

The non-cutting recess 23 is formed to be recessed, in a radial direction of the packaging roller, within the cutting protrusion 22. The non-cutting recess 23 is arranged at a middle portion of the teeth-like blade 24 in the widthwise direction of the cutting protrusion 22. Due to the non-cutting recess 23, as illustrated in FIG. 2, the non-continuous zigzag cut line 21 composed of peak-shaped cuts and valley-shaped cuts that are alternately arranged and disconnected from each other by the uncut portions is formed.

Next, a drug packaging method performed by the drug packaging device 1 having the structure described above will be described with reference to FIGS. 1 to 4.

As illustrated in FIG. 1, when a drug packaging member P passes between the packaging rollers 14 of the packaging unit 10, the drug packaging member P is pressed between the first pressing portions 15 of the packaging rollers 14 and between the second pressing portions 16 of the packaging rollers 14, so that the drug packaging member P is provided with the isolation region 11 consisting of the first bonded portion 12 and the second bonded portion 13, as illustrated in FIG. 2. At this point, as illustrated in FIG. 4, the teeth-like blade 24 of the cutting protrusion 22 installed in the installation recess 18 of either one packaging roller of the pair of packaging rollers 14 forms the non-continuous cut line 21 in the second bonded region 13 of the drug packaging member P. At this point, as illustrated in FIG. 3, due to the non-cutting recess 23 in the cutting protrusion 22, the uncut portions are provided at middle portions between the peak-shaped cuts and the valley-shaped cuts arranged in a zigzag pattern in the drug packaging member P so that the non-continuous zigzag cut line 21 is formed as illustrated in FIG. 2.

Although a preferred embodiment of the present invention has been described for illustrative purposes, those skilled in the art will appreciate that various modifications, additions and substitutions are possible, without departing from the scope and spirit of the invention as disclosed in the accompanying claims.

### INDUSTRIAL APPLICABILITY

The present invention can apply to a drug packaging device for use in hospitals, pharmacies, or households.

1. A drug packaging device comprising:
a packaging unit including a pair of packaging rollers that are pressed against each other with a drug packaging member disposed therebetween, the packaging unit forming at least one drug accommodation section accommodating a drug, by forming isolation regions at regular intervals in the drug packaging member; and
a cutting unit forming a non-continuous zigzag cut line in which peak-shaped cuts and valley-shaped cuts alternately occur and are separated from each other by a plurality of uncut portions.

2. The drug packaging device according to claim 1, wherein the uncut portions are formed at middle portions of linear lines connecting the peak-shaped cuts and the valley-shaped cuts.

3. The drug packaging device according to claim 2, wherein the cutting unit comprises:
a cutting protrusion provided to at least one packaging roller of the pair of packaging rollers and configured to form the peak-shaped cuts and the valley-shaped cuts in the non-continuous zigzag cut line;
a non-cutting recess formed in the cutting protrusion and configured to form the uncut portions in the non-continuous zigzag cut line.

4. The drug packaging device according to claim 3, wherein the cutting protrusion includes a teeth-like blade having a zigzag pattern and the non-cutting recess is provided at a middle portion of the teeth-like blade in a widthwise direction of the cutting protrusion.

5. The drug packaging device according to claim 3, wherein the drug packaging member is provided such that one drug packaging sheet is folded to be partially overlapped or a plurality of drug packaging sheets is arranged to be layered,
the pair of packaging rollers are rotated and pressed against each other with the drug packaging member disposed between the packaging rollers, thereby forming the isolation region that is a thermally bonded region,
the isolation region includes a first bonded region extending in a lengthwise direction of the drug packaging member and a second bonded region extending in a widthwise direction of the drug packaging member, and
the packaging rollers comprise:
respective first pressing portions being pressed against each other in a radial direction of the packaging rollers to form the first bonded region;
respective second pressing portions extending in a lengthwise direction of the packaging rollers and being pressed against each other to form the second bonded region; and
respective packaging portions spaced from each other to form the drug accommodation section therebetween.

6. The drug packaging device according to claim 5, wherein the cutting protrusion is provided to at least one second pressing portion of the second pressing portions of the pair of packaging rollers, configured to extend in the lengthwise direction of the packaging roller, and provided with a teeth-like blade having a zigzag form; and
the non-cutting recesses are formed to be recessed in the pair of cutting protrusions in a radial direction of the pair of packaging rollers, and are provided at a middle portion of the teeth-like blade in a widthwise direction of the pair of cutting protrusions.

7. The drug packaging device according to claim 1, wherein the drug packaging member is made of polyester (PET).

8. A drug packaging device comprising:
a pair of packaging rollers for producing a drug packaging member having a first bonded region extending in a lengthwise direction of the drug packaging member and a second bonded region extending in a widthwise direction of the drug packaging member; and
cutting units respectively inserted in the pair of packaging rollers, thereby forming a non-continuous zigzag cut line in the second bonded region, the non-continuous zigzag cut line including peak-shaped cuts and valley-shaped cuts that are alternately arranged and separated from each other by a plurality of uncut portions,
wherein the pair of packaging rollers are rotated and pressed against each other, thereby forming the first bonded region and the second bonded region,
wherein each of the pair of packaging rollers comprises:
first pressing portions provided at upper and lower ends in the lengthwise direction of the drug packaging member to form the first bonded region, arranged to face each other, and having a disk shape such that the first pressing portions are pressed against each other;
second pressing portions to form the second bonded region, the second pressing portions having a rectangular plate shape and connecting the first pressing portions to each other, wherein the second pressing portions of the packaging rollers are pressed against each other when the packaging rollers are rotated by an angle of 180°.

9. The drug packaging device according to claim 8, wherein the cutting unit further comprises a blade protruding from the second pressing portion, and
wherein the blade comprises:
a teeth-like cutting protrusion having a zigzag form in which peak portions and valley portions are alternatively arranged; and
a non-cutting recess recessed in the cutting protrusion to enable the non-continuous zigzag cut line to have an uncut portion.

10. The drug packaging device according to claim 9, wherein the non-cutting recess is formed at a middle portion of a linear line connecting the peak portion and the valley portion.
